(19) United States
(12) Patent Application Publication
(10) Pub. No.: US 2026/0104660 A1
(43) Pub. Date: Apr. 16, 2026

(54) IMAGE FORMING APPARATUS INCLUDING PHOTOCONDUCTOR DRUM AND PRIMARY TRANSFER ROLLER

(71) Applicant: KYOCERA Document Solutions Inc., Osaka (JP)

(72) Inventors: Teppei SHIBUYA, Osaka (JP); Sadanori NAKAE, Osaka (JP); Ryosuke KIMURA, Osaka (JP)

(73) Assignee: KYOCERA Document Solutions Inc., Osaka (JP)

(21) Appl. No.: 19/339,963

(22) Filed: Sep. 25, 2025

(30) Foreign Application Priority Data
Sep. 27, 2024 (JP) 2024-169541

(51) Int. Cl. G03G 15/16; G03G 15/01

(52) U.S. Cl. CPC G03G 15/161; G03G 15/162; G03G 15/0131; G03G 15/0189

(57) ABSTRACT

An image forming apparatus includes a photoconductor drum, an intermediate transfer belt that moves in contact with the photoconductor drum, and a primary transfer roller that transfers a toner image on the photoconductor drum, to the intermediate transfer belt. A part of a first contact region between the intermediate transfer belt and the photoconductor drum, and a part of a second contact region between the intermediate transfer belt and the primary transfer roller, are made to overlap. A summit of the primary transfer roller, closest to the photoconductor drum in a direction in which the photoconductor drum and the primary transfer roller are aligned across the intermediate transfer belt, is set to intrude on the photoconductor drum, via the intermediate transfer belt. An intrusion amount of the summit of the primary transfer roller on the photoconductor drum, relative to an overlapping amount, is set within a predetermined proper range.

### INCORPORATION BY REFERENCE

This application claims priority to Japanese Patent Application No. 2024-169541 filed on Sep. 27, 2024, the entire contents of which are incorporated by reference herein.

### BACKGROUND

The present disclosure relates to an image forming apparatus that forms an image by an electrophotographic method, and in particular to a technique to appropriately set a positional relation between a photoconductor drum and a primary transfer roller.

Existing electrophotographic image forming apparatuses are configured to form an electrostatic latent image on the surface of a photoconductor drum, apply toner to the electrostatic latent image thereby forming a toner image on the surface of the photoconductor drum, press an endless intermediate transfer belt against the photoconductor drum with a transfer roller, thereby transferring the toner image from the photoconductor drum to the intermediate transfer belt, as primary transfer, and transfer the toner image from the intermediate transfer belt to a recording sheet, as secondary transfer.

In many of known image forming apparatuses, the primary transfer roller is mounted such that the rotational center thereof is located on the downstream side with respect to the rotational center of the photoconductor drum, in the revolving direction of the intermediate transfer belt. The intermediate transfer belt includes a base layer, and a surface layer provided on the outer circumferential surface of the base layer. In addition, the surface resistivity of the intermediate transfer belt is set so as to satisfy 0.75≤N/G≤1.2, where G represents the surface resistivity measured from the side of the outer circumferential surface of the intermediate transfer belt, and N represents the surface resistivity measured from the side of the inner circumferential surface of the intermediate transfer belt. With such a setting, splashing of the toner and appearance of a discharge crater can be prevented, despite the primary transfer roller being offset to the downstream side, with respect to the photoconductor drum.

### SUMMARY

The disclosure proposes further improvement of the foregoing technique.

In an aspect, the disclosure provides an image forming apparatus including a photoconductor drum, an intermediate transfer belt, and a primary transfer roller. The photoconductor drum carries an electrostatic latent image, which is developed into a toner image by application of toner. The intermediate transfer belt is made to move in contact with the photoconductor drum. The primary transfer roller is opposed to the photoconductor drum via the intermediate transfer belt, and presses the intermediate transfer belt against the photoconductor drum, thereby transferring the toner image on the photoconductor drum, to the intermediate transfer belt from the photoconductor drum. A part of a first contact region and a part of a second contact region are made to overlap with each other, the first contact region being a contact region between the intermediate transfer belt and the photoconductor drum, and the second contact region being a contact region between the intermediate transfer belt and the primary transfer roller. A summit of the primary transfer roller, protruding farthest toward the photoconductor drum, in a direction in which the photoconductor drum and the primary transfer roller are aligned across the intermediate transfer belt, is set to intrude on the photoconductor drum, via the intermediate transfer belt.

### BRIEF DESCRIPTION OF THE DRAWINGS

FIG. 1 is a cross-sectional view showing an image forming apparatus according to an embodiment of the disclosure;

FIG. 2 is a side view showing an intermediate transfer unit and related components, in the image forming apparatus according to the embodiment;

FIG. 3 is an enlarged schematic drawing showing an intermediate transfer belt, and one set of a primary transfer roller and a photoconductor drum, in the intermediate transfer unit;

FIG. 4 is a partially enlarged view from FIG. 3, showing a first contact region between the intermediate transfer belt and the photoconductor drum, a second contact region between the intermediate transfer belt and the primary transfer roller, and an overlapping region of the second contact region overlapping with the first contact region;

FIG. 5A presents conditions of an experiment 1;

FIG. 5B is a table showing whether banding has appeared through the experiment 1;

FIG. 6A is a table showing whether banding has appeared through an experiment 2-1;

FIG. 6B is a table showing whether a drum ghost has appeared through an experiment 2;

FIG. 7A is a table showing whether banding has appeared through an experiment 2-2;

FIG. 7B is a table showing whether a drum ghost has appeared through the experiment 2;

FIG. 8A is a table showing whether banding has appeared through an experiment 2-3;

FIG. 8B is a table showing whether a drum ghost has appeared through the experiment 2;

FIG. 9A is a table showing whether banding has appeared through an experiment 2-4;

FIG. 9B is a table showing whether a drum ghost has appeared through the experiment 2;

FIG. 10A, FIG. 10B, and FIG. 10C are schematic drawings each showing the drum ghost that appeared on the surface of the photoconductor drum;

FIG. 11 is a graph showing maximum pressure PM of a nip region relative to a load N of the primary transfer roller, measured when an offset amount F was set to 0 mm, 2.0 mm, 4.0 mm, and 6.0 mm; and

FIG. 12 is a graph showing mottle indices relative to the maximum pressure PM of the nip region, acquired when the offset amount F was set to 0 mm, 2.0 mm, 4.0 mm, and 6.0 mm.

### DETAILED DESCRIPTION

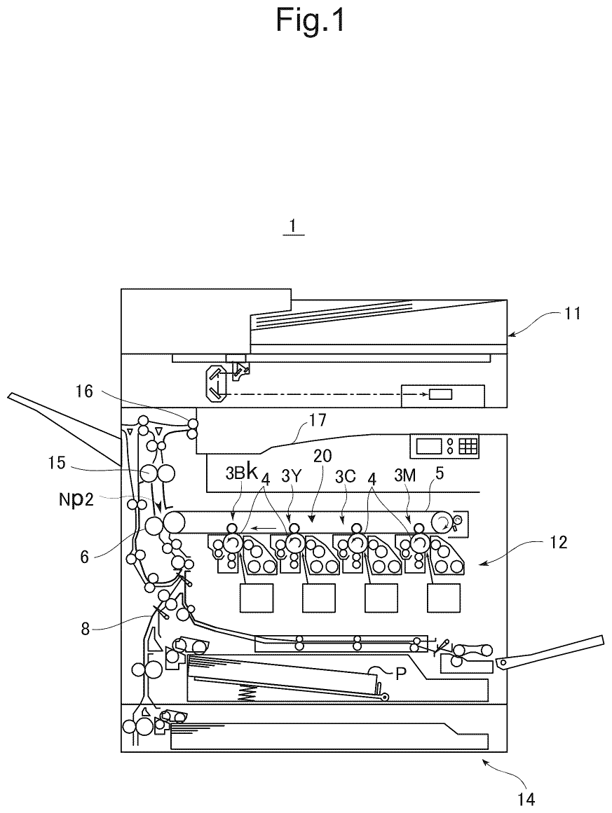

Hereafter, an image forming apparatus according to an embodiment of the disclosure will be described, with reference to the drawings. FIG. 1 is a cross-sectional view showing the image forming apparatus according to the embodiment of the disclosure. The image forming apparatus 1 includes an image reading device 11 and an image forming device 12.

The image reading device 11 includes an image sensor that optically reads the image of a document. An analog output from the image sensor is converted into a digital signal, and image data representing the image of the document is generated.

The image forming device 12 serves to print the image represented by the image data, on a recording sheet P, and includes an image forming unit 3M for magenta, an image forming unit 3C for cyan, an image forming unit 3Y for yellow, and an image forming unit 3Bk for black. In each of the image forming units 3M, 3C, 3Y, and 3Bk, the surface of a photoconductor drum 4 is uniformly charged and exposed, to thereby form an electrostatic latent image on the surface of the photoconductor drum 4, and then the electrostatic latent image on the surface of the photoconductor drum 4 is developed into a toner image, which is transferred to an intermediate transfer belt 5 in an intermediate transfer unit. As result, a colored toner image is formed on the intermediate transfer belt 5. The colored toner image is transferred, as secondary transfer, to the recording sheet P transported from a sheet feeding device 14 along a transport route 8, at a nip region NP2 between the intermediate transfer belt 5 and a secondary transfer roller 6.

Thereafter, a fixing device 15 heats and presses the recording sheet P, to fix the toner image onto the recording sheet P, by thermal compression, and then the recording sheet P is delivered to an output tray 17, via a delivery roller 16.

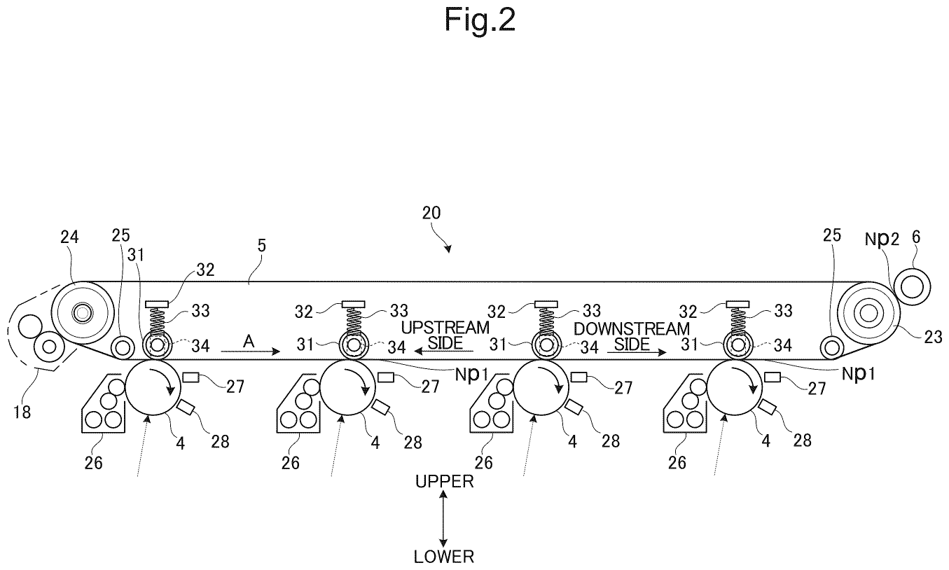

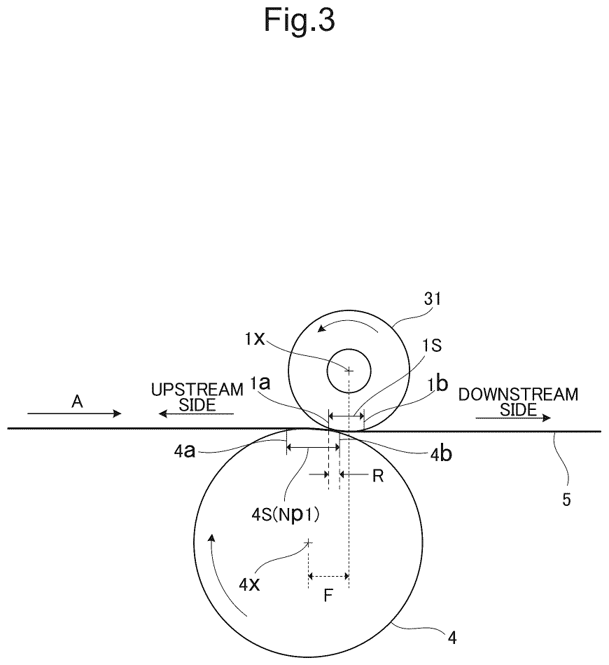

FIG. 2 is a side view showing an intermediate transfer unit 20. FIG. 2 illustrates the configuration of the intermediate transfer unit 20, seen from the opposite side of the image forming apparatus 1 shown in FIG. 1. As shown in FIG. 2, the intermediate transfer unit 20 includes four primary transfer rollers 31, a drive roller 23, a tension roller 24, and two backup rollers 25 (not shown in FIG. 1). The intermediate transfer belt 5 is stretched around the drive roller 23, the tension roller 24, and the backup rollers 25, and the primary transfer rollers 31 are pressed against the respectively corresponding photoconductor drums 4, via the intermediate transfer belt 5. When the drive roller 23 is made to rotate, the intermediate transfer belt 5 revolves in contact with each of the photoconductor drums 4, so that the toner image of each color is transferred from the photoconductor drum 4 to the intermediate transfer belt 5. A belt cleaning device 18 removes the toner remaining on the surface of the intermediate transfer belt 5. The primary transfer rollers 31 each extend in the direction orthogonal to the moving direction A of the intermediate transfer belt 5, in other words in the width direction of the intermediate transfer belt 5. The rotation shaft 1x (see FIG. 3) of the intermediate transfer belt 5 also extends in the width direction.

The primary transfer roller 31 is, for example, formed of a conductive roller including a conductive rubber material. The primary transfer roller 31 includes a conductive layer provided over the outer circumferential surface of a circular column-shaped core metal formed of stainless steel or iron. The conductive layer is formed of a rubber material (e.g., nitrile rubber (NBR), ethylene propylene diene monomer rubber (EPDM), or epichlorohydrin rubber), to attain a stable resistance.

The backup rollers 25 are, as shown in FIG. 2, located on the front side and the rear side respectively, of the four sets of the photoconductor drum 4 and the corresponding primary transfer roller 31, in the moving direction A of the intermediate transfer belt 5. The backup roller 25 is, for example, a metal roller with knurled surface.

The primary transfer rollers 31 each have the rotation shaft supported by a bearing 34 provided on each of end portions of the primary transfer roller 31. The rotation shaft of the primary transfer roller 31 is movable in the up-down direction via the bearing 34. On the upper side of the bearing 34, a stopper 32 is provided, with a spacing from the bearing 34. Between the bearing 34 and the stopper 32, a compressed spring 33 is provided, to press the bearing 34 of the primary transfer roller 31 against the intermediate transfer belt 5, with the biasing force of the spring 33. Thus, the spring 33 is a pressing spring. Accordingly, the primary transfer roller 31 is pressed against the intermediate transfer belt 5, and also against the photoconductor drum 4, via the intermediate transfer belt 5. Here, the spring 33 corresponds to the biasing device in the disclosure.

On the lower side of the intermediate transfer belt 5, a developing device 26, a drum cleaning device 27, and a charging device 28 are provided for each of the photoconductor drums 4. The photoconductor drums 4 are each made to rotate in the direction indicated by arrows in FIG. 2, so that as the photoconductor drum 4 rotates, the surface thereof is uniformly charged by the charging device 28, and exposed by a non-illustrated exposure device. Accordingly, an electrostatic latent image is formed on the surface of the photoconductor drum 4, and toner is applied by the developing device 26 to the electrostatic latent image on the surface of the photoconductor drum 4, so that the electrostatic latent image is developed into a toner image, which is transferred, as primary transfer, to the surface of the intermediate transfer belt 5, with the pressure applied by the primary transfer roller 31. Thereafter, the surface of the photoconductor drum 4 is destaticized, and the residual toner on the surface of the photoconductor drum 4 is removed by the drum cleaning device 27.

As described above, a colored toner image, formed by overlaying the toner images on the surface of the respective photoconductor drums 4 on each other, is formed on the intermediate transfer belt 5, and such colored toner image is transferred, as secondary transfer, from the intermediate transfer belt 5 to the recording sheet P, at the nip region NP2 between the intermediate transfer belt 5 and the secondary transfer roller 6.

The image forming apparatus 1 according to this embodiment includes four sets of the photoconductor drum 4 and the primary transfer roller 31, each set being composed of the photoconductor drum 4, and the primary transfer roller 31 pressed against the photoconductor drum 4 via the intermediate transfer belt 5. In each set of the photoconductor drum 4 and the primary transfer roller 31, a downstream-side portion of a first contact region on the photoconductor drum 4, in contact with the intermediate transfer belt 5 on the upstream side of the secondary transfer roller 6, in the moving direction A of the intermediate transfer belt 5, and an upstream-side portion of a second contact region on the intermediate transfer belt 5, in contact with the primary transfer roller 31, are located so as to overlap with each other, along the moving direction A.

In addition, the summit of the primary transfer roller 31, protruding farthest toward the photoconductor drum 4, in the direction in which the photoconductor drum 4 and the primary transfer roller 31 are aligned via the intermediate transfer belt 5 (up-down direction in FIG. 2), is located so as to intrude into a side where the photoreceptor drum 4 is located, via the intermediate transfer belt 5. In this embodiment, further, the intrusion amount of the summit of the primary transfer roller 31 toward the photoconductor drum 4, relative to the overlapping amount between the first contact region and the second contact region, is set to be within a predetermined proper range.

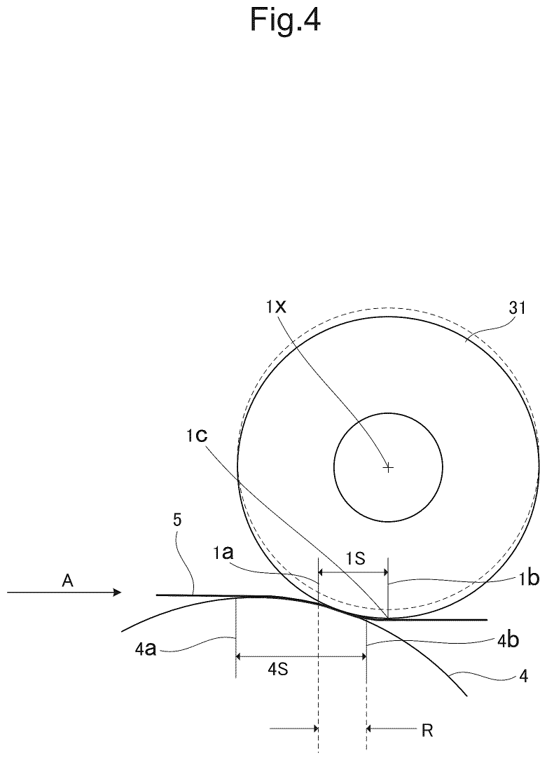

FIG. 3 is an enlarged schematic drawing showing the primary transfer roller 5, and one set of the photoconductor drum 4 and the primary transfer roller 31. FIG. 4 is a partially enlarged view from FIG. 3, showing the first contact region, the second contact region, and the overlapping region of the second contact region overlapping with the first contact region. As shown in FIG. 3, the set of the photoconductor drum 4 and the primary transfer roller 31 is located upstream of the secondary transfer roller 6 (not shown in FIG. 3), in the moving direction A of the intermediate transfer belt 5.

The downstream-side portion of a first contact region 4S on the photoconductor drum 4, and the upstream-side portion of a second contact region 1S on the primary transfer roller 31, are set to overlap with each other, the first contact region 4S representing the contact region on the photoconductor drum 4 with the intermediate transfer belt 5, and the second contact region 1S representing the contact region on the primary transfer roller 31 with the intermediate transfer belt 5. The term “overlap” herein used refers to the state where a part of the second contact region 1S and a part of the first contact region 4S are overlaid on each other, along the moving direction A. In FIG. 3 and FIG. 4, the overlapping amount is indicated by “R”.

To be more detailed, when the upstream end of the first contact region 4S is denoted as 4a, the downstream end thereof is denoted as 4b, the upstream end of the second contact region 1S is denoted as 1a, and the downstream end thereof is denoted as 1b, in the moving direction A of the intermediate transfer belt 5, the upstream end 1a of the second contact region 1S is located on the upstream with respect to the downstream 4b of the first contact region 4S. In addition, when the rotational center of the photoconductor drum 4 is denoted as 4x, and the rotational center of the primary transfer roller 31 is denoted as 1x, the rotational center 1x of the primary transfer roller 31 is spaced from the rotational center 4x of the photoconductor drum 4 to the downstream side, in the moving direction A of the intermediate transfer belt 5, and an offset amount F, corresponding to the distance between the rotational center 4x and the rotational center 1x, is larger than “0”. With such configuration, the downstream-side portion of the first contact region, and the upstream-side portion of the second contact region on the primary transfer roller 31, overlap with each other.

Further, when a range of the second contact region 1S of the primary transfer roller 31, overlapping with the first contact region 4S of the photoconductor drum 4, is denoted as overlapping region R as shown in FIG. 3, setting the overlap area Rs of the overlapping region R to a value smaller than a maximum value Vs of the overlap area Rs allows a part of the second contact region 4S and a part of the first contact region 1S to overlap with each other, in the moving direction A of the intermediate transfer belt 5. In this state, the summit 1c of the primary transfer roller 31, protruding farthest toward the photoconductor drum 4, is intruding into the side where the photoreceptor drum 4 is located via the intermediate transfer belt 5, by an intrusion amount within the predetermined proper range.

The overlap area Rs assumes a maximum value RM, when the photoconductor drum 4 and the primary transfer roller 31 are in contact with the same position on the intermediate transfer belt 5 in the moving direction A (positions coinciding with each other on the front side and the back side of the intermediate transfer belt 5). The more distant from such same position the primary transfer roller 31 is, the narrower the overlap area Rs becomes, thus assuming a value smaller than the maximum value Vs.

In the first contact region 4S, the primary transfer roller 31 is pressed against the photoconductor drum 4 via the intermediate transfer belt 5, so that the intermediate transfer belt 5 is pinched between the photoconductor drum 4 and the primary transfer roller 31. The first contact region 4S serves as a nip region NP1, where the toner image on the photoconductor drum 4 is transferred to the intermediate transfer belt 5.

In the second contact region 1S, the primary transfer roller 31 to which the transfer bias is applied is pressed against the photoconductor drum 4, via the intermediate transfer belt 5. The pressure of the primary transfer roller 31, applied to the photoconductor drum 4 via the intermediate transfer belt 5 in the second contact region 1S, serves to enhance the transfer performance of the toner image from the photoconductor drum 4 to the intermediate transfer belt 5.

When the downstream-side portion of the first contact region 4S on the photoconductor drum 4 (nip region NP1), and the upstream-side portion of the second contact region 1S on the primary transfer roller 31 overlap with each other, the pressure applied by the primary transfer roller 31 in the nip region NP1 barely fluctuates, and the pressure to the intermediate transfer belt 5 is stabilized, and therefore an image defect (e.g., banding), arising from the revolving motion of the intermediate transfer belt 5, can be prevented. In addition, the pressure at the nip region NP1 can be efficiently increased to a stable level, without taking the trouble to increase the load imposed on the primary transfer roller 31 by the biasing force of the spring 33. As result, the load imposed on the photoconductor drum 4 and the intermediate transfer belt 5 is alleviated, which leads to a prolonged mechanical service life.

Now, setting the offset amount F, corresponding to the distance between the rotational center of the photoconductor drum 4 and the rotational center of the primary transfer roller 31 in the moving direction A, to a value within the predetermined proper range, with respect to the overlap amount between the second contact region 1S and the first contact region 4S in the moving direction A of the intermediate transfer belt 5, contributes to suppressing appearance of banding arising from the revolving motion of the intermediate transfer belt 5, thereby improving the image quality, and further assures that the mechanical service life of the photoconductor drum 4 and the intermediate transfer belt 5 is prevented from being shortened.

However, when the downstream-side portion of the first contact region 4S on the photoconductor drum 4 (nip region NP1), and the upstream-side portion of the second contact region 1S on the primary transfer roller 31 are overlapping with each other, the overlap area Rs becomes narrower, the larger the offset amount F is, and therefore the pressure at the nip region NP1 decreases and becomes unstable, and the transfer performance of the toner image from the photoconductor drum 4 to the intermediate transfer belt 5 becomes unstable.

In this embodiment, accordingly, in the state where a part of the second contact region 4S and a part of the first contact region 1S are overlapping with each other, in the moving direction A of the intermediate transfer belt 5, making the summit 1c of the primary transfer roller 31 intrude into the side where the photoreceptor drum 4 is located, via the intermediate transfer belt 5 by the aforementioned intrusion amount, enables a sufficient pressure at the nip region NP1 necessary for the transfer of the toner to be secured, thereby stabilizing the transfer performance of the toner image from the photoconductor drum 4 to the intermediate transfer belt 5, without taking the trouble to increase the load imposed on the primary transfer roller 31 by the biasing force of the spring 33, even when the offset amount F is large and the overlap area Rs is small. Such an arrangement further assures that the image defect can be suppressed and the image quality can be improved, and that the mechanical service life of the photoconductor drum 4 and intermediate transfer belt can be prolonged.

According to this embodiment, further, specifying the intrusion amount as above leads to stabilized transfer performance of the toner image from the photoconductor drum 4 to the intermediate transfer belt 5, despite the overlap area Rs being small. Therefore, the designing freedom related to the structure of the photoconductor drum 4, the primary transfer roller 31, and the intermediate transfer belt 5 can be widened. Such advantages will be described in further detail, with reference to experiments 1 and 2 to be subsequently described.

### SPECIFIC EXAMPLE OF EMBODIMENT

In this example, the diameter of the photoconductor drum 4 is set to 30 mm, and the diameter of the primary transfer roller 31 is set to 12 mm.

The overlap area Rs assumes the maximum value RM, when the photoconductor drum 4 and the primary transfer roller 31 are in contact with each other at the same position on the intermediate transfer belt 5. When the intrusion amount of the summit 1c of the primary transfer roller 31 toward the photoconductor drum 4, realized when the summit 1c is made to intrude deeper toward the photoconductor drum 4 via the intermediate transfer belt 5, is denoted as an intrusion amount Kr, setting the proper range of the intrusion amount Kr to a value exceeding 0 mm and equal to or less than 0.5 mm, when the overlap area Rs is set to a value exceeding 0% and equal to or less than 40% of the maximum value RM, leads to improved image quality and prolonged mechanical service life, as is apparent from the experiment 2 to be subsequently described.

In addition, as is apparent from the experiment 2 to be subsequently described, when the summit 1c of the primary transfer roller 31 is made to intrude deeper toward the photoconductor drum 4 via the intermediate transfer belt 5, in the state where the overlap area Rs is set to a value exceeding 0% and equal to or less than 30% of the maximum value RM, setting the proper range of the intrusion amount Kr of the summit 1c of the primary transfer roller 31, to a value exceeding 0 mm and equal to or less than 1.0 mm, further assures that the image quality can be improved and the mechanical service life can be prolonged.

Further, as is apparent from the experiment 2 to be subsequently described, when the summit 1c of the primary transfer roller 31 is made to intrude deeper toward the photoconductor drum 4 via the intermediate transfer belt 5, in the state where the overlap area Rs is set to a value exceeding 0% and equal to or less than 20% of the maximum value RM, setting the proper range of the intrusion amount Kr of the summit 1c of the primary transfer roller 31, to a value exceeding 0 mm and equal to or less than 1.5 mm, further assures that the image quality can be improved and the mechanical service life can be prolonged.

Further, as is apparent from the experiment 2 to be subsequently described, when only the offset amount F is focused on, setting the offset amount F to be in a range of 0.5 mm≤F≤6.0 mm, leads to improved image quality and prolonged mechanical service life.

Preferably, as is apparent from the experiment 2 to be subsequently described, the offset amount F may be set to be in a range of 3.0 mm≤F≤6.0 mm, in which case it can be further assured that the image quality can be improved, and the mechanical service life can be prolonged.

A load N, imposed on the primary transfer roller 31 by the biasing force of the spring 33, is determined according to the size of the recording sheet. Since the spring 33 is, as already described, biasing the primary transfer roller 31 toward the intermediate transfer belt 5, thereby pressing the primary transfer roller 31 against the photoconductor drum 4 via the intermediate transfer belt 5, the load N can be set to an appropriate value, in addition to the overlap area Rs (exemplifying the overlap amount) and the intrusion amount Kr, by adjusting the biasing force of the spring 33.

For example, when the maximum size of the recording sheet is the standard A3, and the width of the intermediate transfer belt 5 is designed so as to fit the A3 size, it is preferable to set the load N, to be applied to the primary transfer roller 31 by the biasing force of the spring 33, to be in a range between 0.6N and 3.0N, both ends inclusive.

When the maximum size of the recording sheet is the standard A4, and the width of the intermediate transfer belt 5 is designed so as to fit the A4 size, it is preferable to set the load N, to be applied to the primary transfer roller 31 by the biasing force of the spring 33, to be in a range between 0.6N and 1.4N, both ends inclusive. In such cases, the pressure applied to the intermediate transfer belt 5, per unit area thereof, can be set to an appropriate level.

Further, one of the items mentioned below may be combined with (i) a combination of the overlap area Rs (exemplifying the overlap amount) and the intrusion amount Kr, or (ii) the combination of (i) and the load N.

When an elastic belt is adopted as the intermediate transfer belt 5, the thickness of the intermediate transfer belt 5 is set to be in a range from 30 μm to 400 μm, both ends inclusive, and when a resin belt is adopted as the intermediate transfer belt 5, the thickness of the intermediate transfer belt 5 is set to be in a range from 30 μm to 150 μm, both ends inclusive. The elastic belt, also called an intermediate transfer belt with elastic layer, is formed by stacking a plurality of layers including the elastic layer. The resin belt is, for example, formed by applying a coating layer onto the surface of the resin belt.

In addition, the tension of the intermediate transfer belt 5 is set to be in a range from 15N to 45N, both ends inclusive.

Further, a transfer current It, flowing between the primary transfer roller 31 and the photoconductor drum 4, when the transfer bias is being applied to the primary transfer roller 31, is set to be in a range of |2.0 μA|≤It≤|40.0 μA|.

Preferably, the transfer current It may be set to be in a range from −3.0 μA to −15.0 μA, both ends inclusive, according to the permittivity of the photoconductor drum 4, and the type of the toner.

### Experiment 1

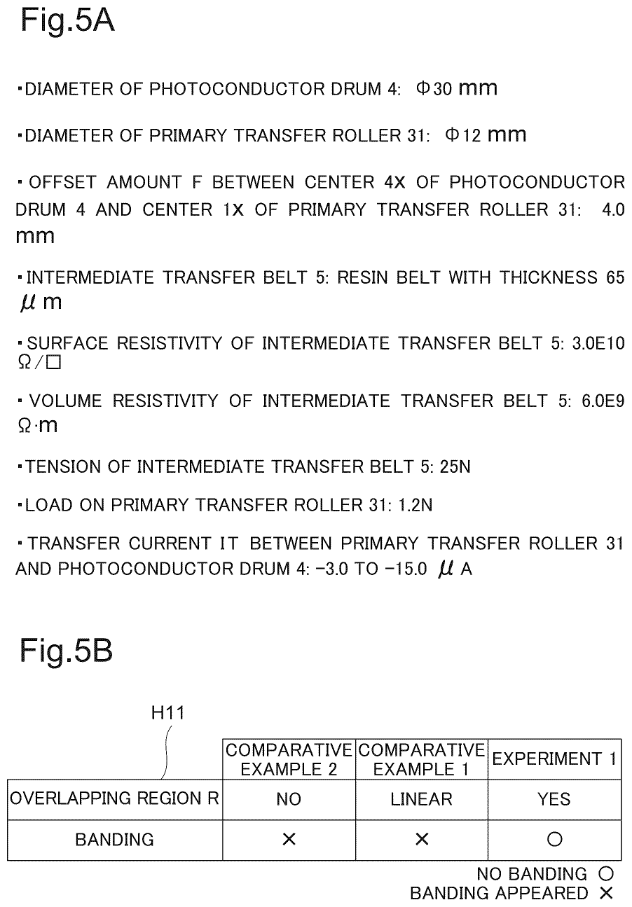

The conditions of the experiment 1 are as shown in FIG. 5A. The diameter of the photoconductor drum 4 was set to 30 mm, and the diameter of the primary transfer roller 31 was set to 12 mm, as in the mentioned specific examples of this embodiment.

According to the conditions of the experiment 1, the offset amount F, between the rotational center 4x of the photoconductor drum 4 and the rotational center 1x of the primary transfer roller 31, along the moving direction A of the intermediate transfer belt 5, is set to 4.0 mm.

According to the conditions of the experiment 1, the summit 1c of the primary transfer roller 31 is made to intrude deeper toward the photoconductor drum 4 via the intermediate transfer belt 5, with the overlap area Rs of the overlapping region R, where the first contact region 4S on the photoconductor drum 4 and the second contact region 1S on the primary transfer roller 31 overlap with each other, set to 25% of the maximum value RM of the overlap area Rs, such that the intrusion amount Kr of the summit 1c of the primary transfer roller 31 becomes 0.5 mm.

According to the conditions of the experiment 1, further, a resin belt having a thickness of 65 μm is adopted as the intermediate transfer belt 5. The surface resistivity of the intermediate transfer belt 5 is 3.0E10 Ω/□ (ohms per square), and the volume resistivity of the intermediate transfer belt 5 is 6.0E9 Ω·m.

According to the conditions of the experiment 1, further, the tension of the intermediate transfer belt 5 is set to 25N. The load imposed on the primary transfer roller 31 by the spring 33 is set to 1.2N.

According to the conditions of the experiment 1, still further, the transfer current It flowing between the primary transfer roller 31 and the photoconductor drum 4 is set to be in a range from −3.0 to −15.0 μA, both ends inclusive.

Under the conditions of the experiment 1, the electrostatic latent images on the respective photoconductor drums 4 were developed, to form the toner image on the photoconductor drums 4, and the toner images on the surface of the respective photoconductor drums 4 were transferred to the intermediate transfer belt 5 by the corresponding primary transfer roller 31, as primary transfer. The results of the experiment 1 are shown in a table H11 of FIG. 5B. In the table H11 of FIG. 5B, a circle indicates that banding has not appeared, and a cross indicates that the banding has appeared. Through the experiment 1, the colored toner image formed on the intermediate transfer belt 5 has not suffered the banding (horizontal stripe).

As a comparative example 1 shown in the table H11, the offset amount F was changed to “0” from the condition of the experiment 1, in other words the rotational center 4x of the photoconductor drum 4 and the rotational center 1x of the primary transfer roller 31 were set to coincide with each other, in the moving direction of the intermediate transfer belt 5. In this case, the photoconductor drum 4 and the primary transfer roller 31 make a linear contact with each other, along the same positions on the intermediate transfer belt 5 (positions coinciding with each other on the front face and the back face of the intermediate transfer belt 5).

In addition, as a comparative example 2 shown in the table H11, the offset amount F was changed to a larger value from the condition of the experiment 1, in other words the first contact region 4S on the photoconductor drum 4 was shifted away from the second contact region 1S on the primary transfer roller 31. In this case, the overlap area Rs becomes “0”.

As shown in the table H11 of FIG. 5B, the colored toner image formed on the intermediate transfer belt 5 suffered an image defect (banding), in both of the comparative example 1 and the comparative example 2.

From the results of the experiment 1, the comparative example 1, and the comparative example 2, it can be understood that, when the downstream-side portion of the first contact region 4S on the photoconductor drum 4 (nip region NP1), and the upstream-side portion of the second contact region 1S on the primary transfer roller 31 are made to overlap with each other, and the summit 1c of the primary transfer roller 31 is made to intrude toward the photoconductor drum 4 via the intermediate transfer belt 5, the pressure from the primary transfer roller 31 to the nip region NP1 can be suppressed from fluctuating, and a sufficient pressure for transferring the toner can be secured at the nip region NP1, without the need to increase the spring load applied to the primary transfer roller 31. Therefore, the appearance of the banding can be suppressed, and the mechanical service life of the photoconductor drum 4 and the intermediate transfer belt 5 can be prolonged.

### Experiment 2

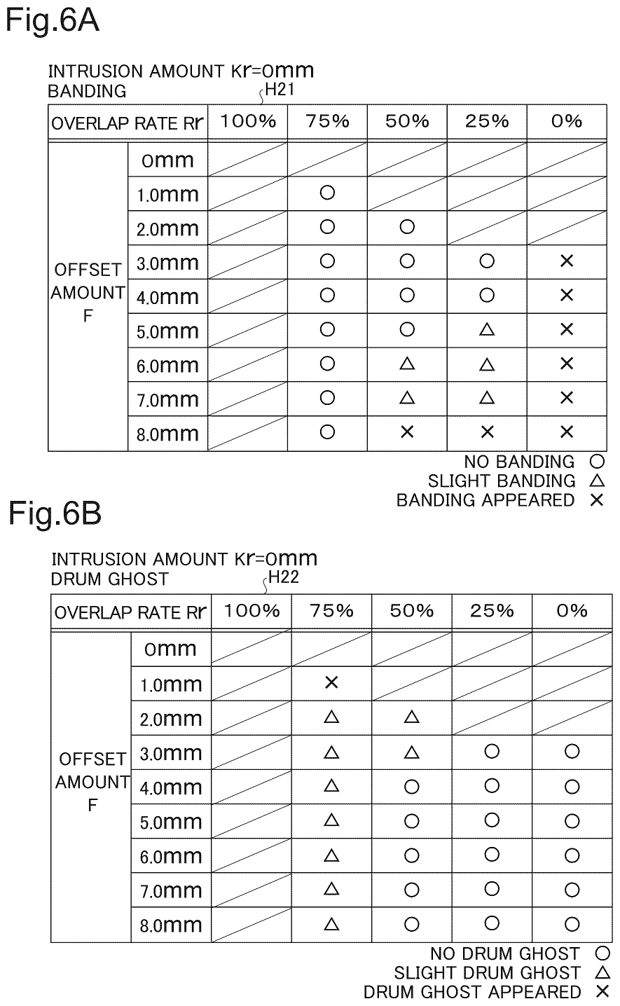

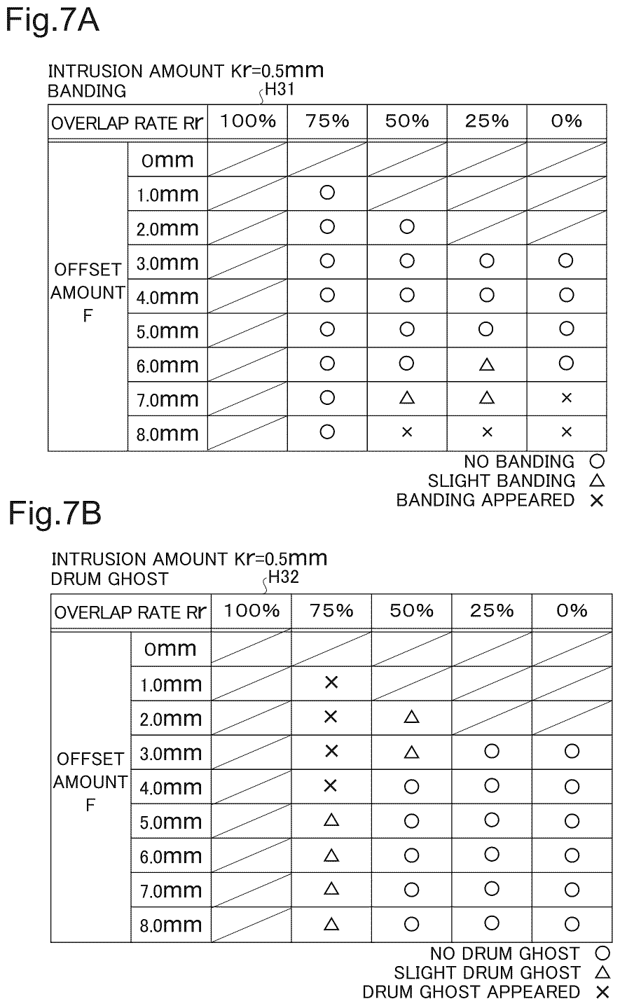

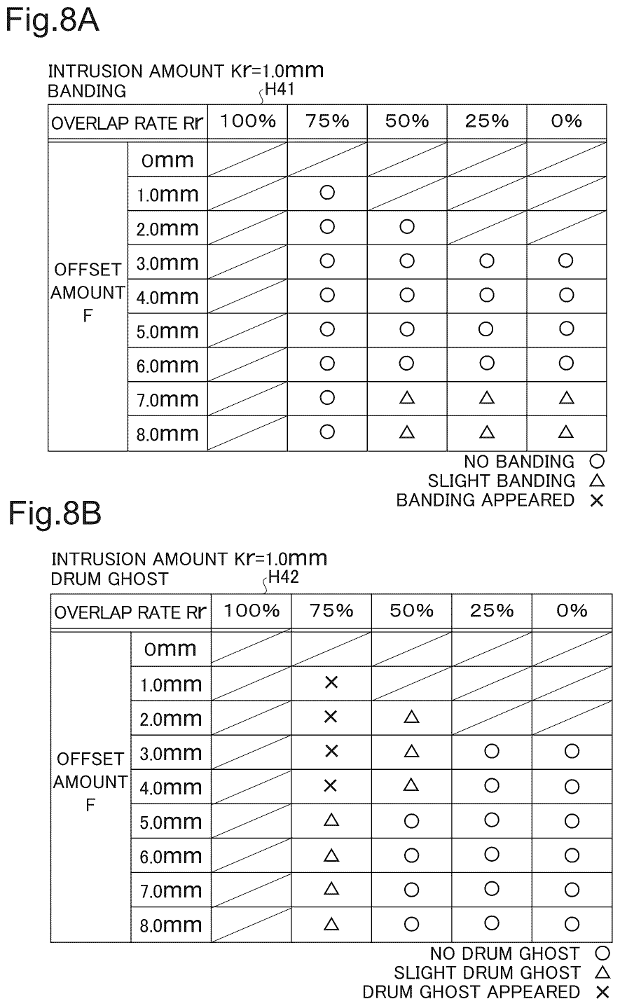

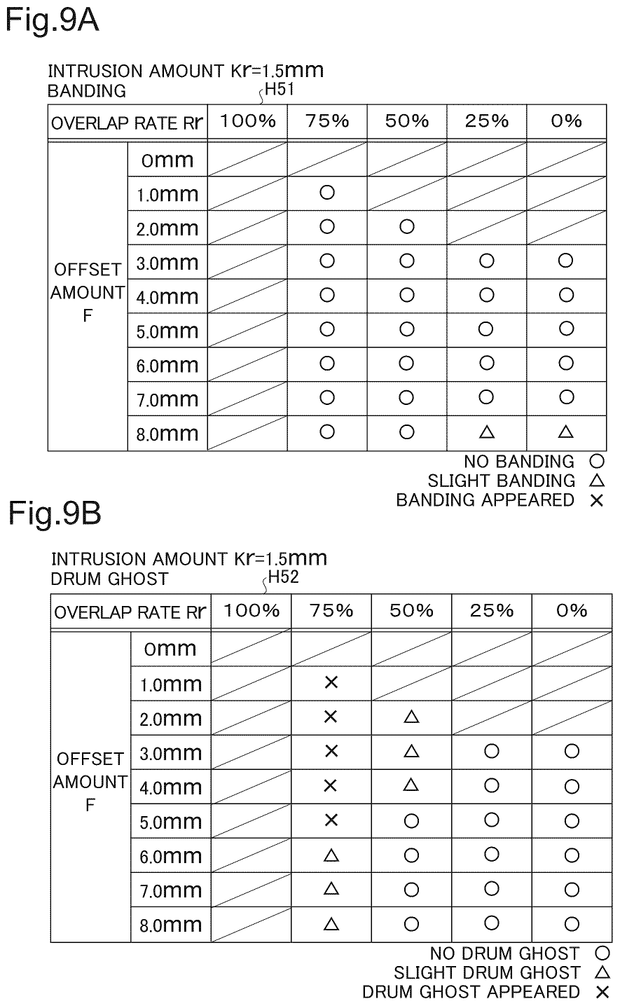

The experiment 2 includes four phases, namely an experiment 2-1, an experiment 2-2, an experiment 2-3, and an experiment 2-4. The results of the experiment 2-1 are shown in a table H21 and a table H22 of FIG. 6A and FIG. 6B, respectively, the results of the experiment 2-2 are shown in a table H31 and a table H32 of FIG. 7A and FIG. 7B, respectively, the results of the experiment 2-3 are shown in a table H41 and a table H42 of FIG. 8A and FIG. 8B, respectively, and the results of the experiment 2-4 are shown in a table H51 and a table H52 of FIG. 9A and FIG. 9B, respectively.

For the experiment 2-1, the intrusion amount Kr was set to 0 mm, for the experiment 2-2 the intrusion amount Kr was set to 0.5 mm, for the experiment 2-3 the intrusion amount Kr was set to 1.0 mm, and for the experiment 2-4 the intrusion amount Kr was set to 1.5 mm.

In each of the experiments 2-1 to 2-4, the offset amount F was changed stepwise, and the overlap area Rs was also changed stepwise with respect to each of the offset amounts F, to evaluate the appearance of the banding and a drum ghost. A circle indicates that the banding or the drum ghost was not observed, a triangle indicates that banding or the drum ghost was slightly observed, and a cross indicates that the banding or the drum ghost was observed. Here, the drum ghost refers to such a phenomenon that a trace of the previously transferred image remains on the surface of the photoconductor drum 4, and such trace is overlaid on the next image. The drum ghost is also called a transfer memory.

For the experiments 2-1 to 2-4, the diameter of the photoconductor drum 4 was set to 30 mm, and the diameter of the primary transfer roller 31 was set to 12 mm, as in the experiment 1.

According to the conditions of the experiments 2-1 to 2-4, the resin belt having a thickness of 65 μm is adopted as the intermediate transfer belt 5, as in the experiment 1. The surface resistivity of the intermediate transfer belt 5 is 3.0E10 Ω/□, and the volume resistivity of the intermediate transfer belt 5 is 6.0E9 Ω·m.

According to the conditions of the experiments 2-1 to 2-4, the tension of the intermediate transfer belt 5 is set to 25N, as in the experiment 1.

According to the conditions of the experiments 2-1 to 2-4, further, the transfer current It flowing between the primary transfer roller 31 and the photoconductor drum 4 is set to be in a range from −3.0 to −15.0 μA, both ends inclusive, as in the experiment 1.

According to the conditions of the experiment 2-1, as shown in the table H21 and table H22 of FIG. 6A and FIG. 6B, respectively, the intrusion amount Kr was set to 0 mm, the offset amount F was changed stepwise as 1.0 mm, 2.0 mm, 3.0 mm, 4.0 mm, 5.0 mm, 6.0 mm, 7.0 mm, and 8.0 mm, and the overlap rate Rr was changed stepwise as 75%, 50%, 25%, and 0%, with respect to each of the offset amounts F, to evaluate the appearance of the banding and the drum ghost.

The overlap rate Rr indicates the ratio of the overlap area Rs with respect to the maximum value RM of the overlap area Rs. The primary transfer roller 31 changes the position according to the load N applied to the intermediate transfer belt 5, in other words the biasing force of the spring 33. When the load N based on the biasing force of the spring 33 is increased, until the primary transfer roller 31 comes closest to the photoconductor drum 4, by being pressed against the photoconductor drum 4 via the intermediate transfer belt 5, the photoconductor drum 4 and the primary transfer roller 31 make contact with the same positions on the intermediate transfer belt 5 (positions coinciding with each other on the front face and the back face of the intermediate transfer belt 5), and the overlap area Rs of the overlapping region R in the second contact region 1S, overlapping with the first contact region 4S, assumes the maximum value RM, and thus the overlap rate Rr becomes 100%. In contrast, when the load N based on the biasing force of the spring 33 is decreased, the primary transfer roller 31 moves away from the intermediate transfer belt 5, and therefore the overlap area Rs becomes narrower and the overlap rate Rr is reduced.

In all the cases where the offset amount F is set to 1.0 mm, 2.0 mm, 3.0 mm, 4.0 mm, 5.0 mm, 6.0 mm, 7.0 mm, and 8.0 mm, when the load N is increased until the photoconductor drum 4 and the primary transfer roller 31 make contact with the same positions on the intermediate transfer belt 5, the overlap area Rs assumes the maximum value RM, in other words the overlap rate Rr becomes 100%, and when the load N is decreased, the primary transfer roller 31 moves away from the same contact position, so that the overlap area Rs becomes narrower and the overlap rate Rr is reduced.

According to the table H21 and table H22 of FIG. 6A and FIG. 6B, the evaluation of the appearance of the banding and the drum ghost was not performed when the overlap rate Rr was 100%, with respect to any of the cases where the offset amount F was set to 1.0 mm, 2.0 mm, 3.0 mm, 4.0 mm, 5.0 mm, 6.0 mm, 7.0 mm, and 8.0 mm, because the photoconductor drum 4 and the primary transfer roller 31 were in contact with the same positions on the intermediate transfer belt 5, and the intrusion amount Kr was set to 0 mm and unchangeable.

In addition, when the offset amount F is set to 0 mm, the rotational center 1x of the primary transfer roller 31 is located right above the rotational center 4x of the photoconductor drum 4, and the intrusion amount Kr is set to 0 mm and unchangeable. Therefore, the evaluation of the appearance of the banding and the drum ghost was not performed.

According to the table H21 and table H22 of FIG. 6A and FIG. 6B, since the intrusion amount Kr is set to 0 mm, the summit 1c of the primary transfer roller 31 is not made to intrude deeper toward the photoconductor drum 4, via the intermediate transfer belt 5, from any of the states realized by the combination of the offset amount F of 1.0 mm, 2.0 mm, 3.0 mm, 4.0 mm, 5.0 mm, 6.0 mm, 7.0 mm, or 8.0 mm, and the overlap rate Rr of 75%, 50%, 25%, or 0%.

According to the table H21 and table H22 of FIG. 6A and FIG. 6B, when the offset amount F was set to 1.0 mm and the overlap rate Rr was set to 75%, the banding was not observed, but the drum ghost was observed.

According to the table H21 and table H22 of FIG. 6A and FIG. 6B, further, when the offset amount F was set to 2.0 mm and the overlap rate Rr was set to 75% or 50%, the banding was not observed, and the drum ghost was slightly observed.

The table H21 and table H22 of FIG. 6A and FIG. 6B indicate the evaluation of the appearance of the banding and the drum ghost, with respect to each of the combinations of the offset amount F of 3.0 mm, 4.0 mm, 5.0 mm, 6.0 mm, 7.0 mm, or 8.0 mm, and the overlap rate Rr of 75%, 50%, 25%, or 0%. When the offset amount F was set to 3.0 mm to 7.0 mm, and the overlap rate Rr was set to 75%, 50%, or 25%, the banding was not observed or slightly observed, and when the offset amount F was set to 8.0 mm and the overlap rate Rr was set to 75%, the banding was not observed. Further, when the offset amount F was set to 3.0 mm to 8.0 mm, and the overlap rate Rr was set to 75%, the drum ghost was slightly observed, and when the offset amount F was set to 3.0 mm to 8.0 mm and the overlap rate Rr was set to 50%, 25%, or 0%, the drum ghost was slightly observed, or not observed.

According to the conditions of the experiment 2-2, as shown in the table H31 and the table H32 of FIG. 7A and FIG. 7B, respectively, the intrusion amount Kr was set to 0.5 mm, the offset amount F was changed stepwise as 1.0 mm, 2.0 mm, 3.0 mm, 4.0 mm, 5.0 mm, 6.0 mm, 7.0 mm, and 8.0 mm, and the overlap rate Rr was changed stepwise as 75%, 50%, 25%, and 0% with respect to each of the offset amounts F, to evaluate the appearance of the banding and the drum ghost.

According to the table H31 and table H32 of FIG. 7A and FIG. 7B, the evaluation of the appearance of the banding and the drum ghost was not performed when the overlap rate Rr was 100%, with respect to any of the cases where the offset amount F was set to 1.0 mm, 2.0 mm, 3.0 mm, 4.0 mm, 5.0 mm, 6.0 mm, 7.0 mm, and 8.0 mm, because the photoconductor drum 4 and the primary transfer roller 31 were in contact with the same positions on the intermediate transfer belt 5, and the intrusion amount Kr was set to 0 mm and unchangeable.

In addition, when the offset amount F is set to 0 mm, the rotational center 1x of the primary transfer roller 31 is located right above the rotational center 4x of the photoconductor drum 4, and the intrusion amount Kr is set to 0 mm and unchangeable. Therefore, the evaluation of the appearance of the banding and the drum ghost was not performed.

The table H31 and table H32 of FIG. 7A and FIG. 7B indicate the evaluation of the appearance of the banding and the drum ghost, performed when the offset amount F was set to 1.0 mm, and the overlap rate Rr was set to 75%. When the offset amount F is set to 1.0 mm, the photoconductor drum 4 and the primary transfer roller 31 do not make contact with the same positions on the intermediate transfer belt 5, and the primary transfer roller 31 is slightly shifted from the same contact position. Therefore, the summit 1c of the primary transfer roller 31 can be made to intrude deeper toward the photoconductor drum 4 via the intermediate transfer belt 5, by 0.5 mm, in the state where the overlap rate Rr is set to 75%. With the intrusion amount of 0.5 mm, the banding was not observed, but the drum ghost was observed.

The table H31 and table H32 of FIG. 7A and FIG. 7B indicate the evaluation of the appearance of the banding and the drum ghost, performed when the offset amount F was set to 2.0 mm, and the overlap rate Rr was set to 75% and 50%. When the offset amount F is set to 2.0 mm, the photoconductor drum 4 and the primary transfer roller 31 do not make contact with the same positions on the intermediate transfer belt 5, and the primary transfer roller 31 is slightly shifted from the same contact position. Therefore, the summit 1c of the primary transfer roller 31 can be made to intrude deeper toward the photoconductor drum 4 via the intermediate transfer belt 5, by 0.5 mm, in the state where the overlap rate Rr is set to 75% or 50%. With the intrusion amount of 0.5 mm in the state where the overlap rate Rr was set to 75%, the banding was not observed but the drum ghost was observed, and with the intrusion amount of 0.5 mm in the state where the overlap rate Rr was set to 50%, the banding was not observed, and the drum ghost was slightly observed.

The table H31 and table H32 of FIG. 7A and FIG. 7B indicate the evaluation of the appearance of the banding and the drum ghost, with respect to each of the combinations of the offset amount F of 3.0 mm, 4.0 mm, 5.0 mm, 6.0 mm, 7.0 mm, or 8.0 mm, and the overlap rate Rr of 75%, 50%, 25%, or 0%. When the offset amount F is set to 3.0 mm to 8.0 mm, the photoconductor drum 4 and the primary transfer roller 31 do not make contact with the same positions on the intermediate transfer belt 5, and the primary transfer roller 31 is largely shifted from the same contact position. Therefore, the summit 1c of the primary transfer roller 31 can be made to intrude deeper toward the photoconductor drum 4 via the intermediate transfer belt 5, by 0.5 mm, in the state where the overlap rate Rr was set to 75%, 50%, 25%, or 0%. With the intrusion amount of 0.5 mm in the state where the overlap rate Rr was set to 75%, the banding was not observed, and the drum ghost was observed or slightly observed. With the intrusion amount of 0.5 mm in the state where the overlap rate Rr was set to 50%, the banding was not observed, slightly observed, or observed, and the drum ghost was slightly observed, or not observed. With the intrusion amount of 0.5 mm in the state where the overlap rate Rr was set to 25% or 0%, the banding was not observed, slightly observed, or observed, and the drum ghost was not observed.

According to the conditions of the experiment 2-3, as shown in the table H41 and the table H42 of FIG. 8A and FIG. 8B, respectively, the intrusion amount Kr was set to 1.0 mm, the offset amount F was changed stepwise as 1.0 mm, 2.0 mm, 3.0 mm, 4.0 mm, 5.0 mm, 6.0 mm, 7.0 mm, and 8.0 mm, and the overlap rate Rr was changed stepwise as 75%, 50%, 25%, and 0% with respect to each of the offset amounts F, to evaluate the appearance of the banding and the drum ghost.

According to the table H41 and table H42 of FIG. 8A and FIG. 8B, the evaluation of the appearance of the banding and the drum ghost was not performed, when the overlap rate Rr was set to 100%, and when the offset amount F was set to 0 mm, as in the case of the table H31 and table H32 of FIG. 7a and FIG. 7b.

According to the table H41 and table H42 of FIG. 8A and FIG. 8B, when the summit 1c of the primary transfer roller 31 was made to intrude deeper toward the photoconductor drum 4 via the intermediate transfer belt 5 by 1.0 mm, in the state where the offset amount F was set to 1.0 mm and the overlap rate Rr was set to 75%, the banding was not observed, but the drum ghost was observed.

According to the table H41 and table H42 of FIG. 8A and FIG. 8B, when the summit 1c of the primary transfer roller 31 was made to intrude deeper toward the photoconductor drum 4 via the intermediate transfer belt 5 by 1.0 mm, in the state where the offset amount F was set to 2.0 mm and the overlap rate Rr was set to 75% or 50%, the banding was not observed, and the drum ghost was observed, or slightly observed.

The table H41 and table H42 of FIG. 8A and FIG. 8B indicate the evaluation of the appearance of the banding and the drum ghost, with respect to each of the combinations of the offset amount F of 3.0 mm, 4.0 mm, 5.0 mm, 6.0 mm, 7.0 mm, or 8.0 mm, and the overlap rate Rr of 75%, 50%, 25%, or 0%. In all the cases where the offset amount F was set to 3.0 mm, 4.0 mm, 5.0 mm, 6.0 mm, 7.0 mm, or 8.0 mm, when the summit 1c of the primary transfer roller 31 was made to intrude deeper toward the photoconductor drum 4 via the intermediate transfer belt 5 by 1.0 mm, in the state where the overlap rate Rr was set to 75%, 50%, 25%, or 0%, the banding was not observed or slightly observed, and the drum ghost was observed, slightly observed, or not observed.

According to the conditions of the experiment 2-4, as shown in the table H51 and the table H52 of FIG. 9A and FIG. 9B, respectively, the intrusion amount Kr was set to 1.5 mm, the offset amount F was changed stepwise as 1.0 mm, 2.0 mm, 3.0 mm, 4.0 mm, 5.0 mm, 6.0 mm, 7.0 mm, and 8.0 mm, and the overlap rate Rr was changed stepwise as 75%, 50%, 25%, and 0% with respect to each of the offset amounts F, to evaluate the appearance of the banding and the drum ghost.

According to the table H51 and the table H52 of FIG. 9A and FIG. 9B, the evaluation of the appearance of the banding and the drum ghost was not performed, when the overlap rate Rr was set to 100%, and when the offset amount F was set to 0 mm, as in the case of the table H41 and table H42 of FIG. 8A and FIG. 8B.

According to the table H51 and the table H52 of FIG. 9A and FIG. 9B, when the summit 1c of the primary transfer roller 31 was made to intrude deeper toward the photoconductor drum 4 via the intermediate transfer belt 5 by 1.5 mm, in the state where the offset amount F was set to 1.0 mm and the overlap rate Rr was set to 75%, the banding was not observed, but the drum ghost was observed.

According to the table H51 and the table H52 of FIG. 9A and FIG. 9B, when the summit 1c of the primary transfer roller 31 was made to intrude deeper toward the photoconductor drum 4 via the intermediate transfer belt 5 by 1.5 mm, in the state where the offset amount F was set to 2.0 mm and the overlap rate Rr was set to 75% or 50%, the banding was not observed, and the drum ghost was observed, or slightly observed.

The table H51 and the table H52 of FIG. 9A and FIG. 9B indicate the evaluation of the appearance of the banding and the drum ghost, with respect to each of the combinations of the offset amount F of 3.0 mm, 4.0 mm, 5.0 mm, 6.0 mm, 7.0 mm, or 8.0 mm, and the overlap rate Rr of 75%, 50%, 25%, or 0%. In all the cases where the offset amount F was set to 3.0 mm, 4.0 mm, 5.0 mm, 6.0 mm, 7.0 mm, or 8.0 mm, when the summit 1c of the primary transfer roller 31 was made to intrude deeper toward the photoconductor drum 4 via the intermediate transfer belt 5 by 1.5 mm, in the state where the overlap rate Rr was set to 75%, 50%, 25%, or 0%, the banding was not observed or slightly observed, and the drum ghost was observed, slightly observed, or not observed.

Now, upon focusing on the overlap rate Rr that provides a circle or triangle as the evaluation of the banding, and the overlap rate Rr that provides a circle or triangle as the evaluation of the drum ghost, through comparison between the table H51 and the table H52 of FIG. 9A and FIG. 9B, and upon focusing on the overlap rate Rr that provides a circle or triangle as the evaluation of the banding, and the overlap rate Rr that provides a circle or triangle as the evaluation of the drum ghost, through comparison between the table H31 and table H32 of FIG. 7A and FIG. 7B, it is understood that, when the summit 1c of the primary transfer roller 31 is made to intrude, in the state where the overlap rate Rr is set to a value exceeding 0% and equal to or less than 50%, or more preferably exceeding 0% and equal to or less than 40%, it is preferable to set the offset amount F to be in a range from 3.0 mm to 7.0 mm, both ends inclusive, and set the intrusion amount Kr to a value exceeding 0 mm and equal to or less than 0.5 mm.

In addition, upon focusing on the overlap rate Rr that provides a circle or triangle as the evaluation of the banding, and the overlap rate Rr that provides a circle or triangle as the evaluation of the drum ghost, through comparison between the table H21 and the table H22 of FIG. 6A and FIG. 6B, and upon focusing on the overlap rate Rr that provides a circle or triangle as the evaluation of the banding, and the overlap rate Rr that provides a circle or triangle as the evaluation of the drum ghost, through comparison between the table H41 and table H42 of FIG. 8A and FIG. 8B, it is understood that, when the summit 1c of the primary transfer roller 31 is made to intrude, in the state where the overlap rate Rr is set to a value exceeding 0% and equal to or less than 50%, or more preferably exceeding 0% and equal to or less than 30%, it is preferable to set the offset amount F to be in a range from 3.0 mm to 7.0 mm, both ends inclusive, and set the intrusion amount Kr to a value exceeding 0 mm and equal to or less than 1.0 mm.

Further, upon focusing on the overlap rate Rr that provides a circle or triangle as the evaluation of the banding, and the overlap rate Rr that provides a circle or triangle as the evaluation of the drum ghost, through comparison between the table H21 and the table H22 of FIG. 6A and FIG. 6B, and upon focusing on the overlap rate Rr that provides a circle or triangle as the evaluation of the banding, and the overlap rate Rr that provides a circle or triangle as the evaluation of the drum ghost, through comparison between the table H51 and the table H52 of FIG. 9A and FIG. 9B, it is understood that, when the summit 1c of the primary transfer roller 31 is made to intrude, in the state where the overlap rate Rr is set to a value exceeding 0% and equal to or less than 25%, or more preferably exceeding 0% and equal to or less than 20%, it is preferable to set the offset amount F to be in a range from 3.0 mm to 7.0 mm, both ends inclusive, and set the intrusion amount Kr to a value exceeding 0 mm and equal to or less than 1.5 mm.

As described above, by properly setting the intrusion amount Kr according to the overlap rate Rr and the offset amount F, the circle or the triangle can be attained, in the evaluation of appearance of the banding and the drum ghost.

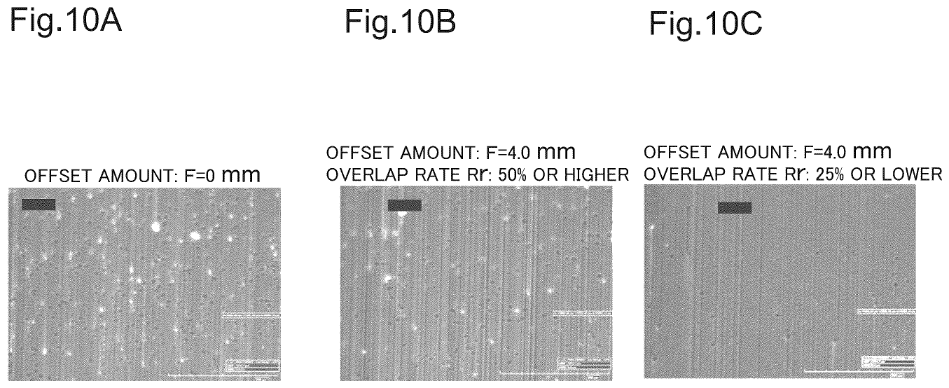

FIG. 10A presents the drum ghost that appeared on the surface of the photoconductor drum 4, when the offset amount F was 0 mm. In FIG. 10A, the drum ghost can be prominently observed. FIG. 10B presents the drum ghost that appeared on the surface of the photoconductor drum 4, when the offset amount F was 4.0 mm, and the overlap rate Rr was equal to or larger than 50%. In FIG. 10B, the drum ghost can be slightly observed. FIG. 10C presents the drum ghost that appeared on the surface of the photoconductor drum 4, when the offset amount F was 4.0 mm, and the overlap rate Rr was equal to or less than 25%. In FIG. 10C, the drum ghost has disappeared.

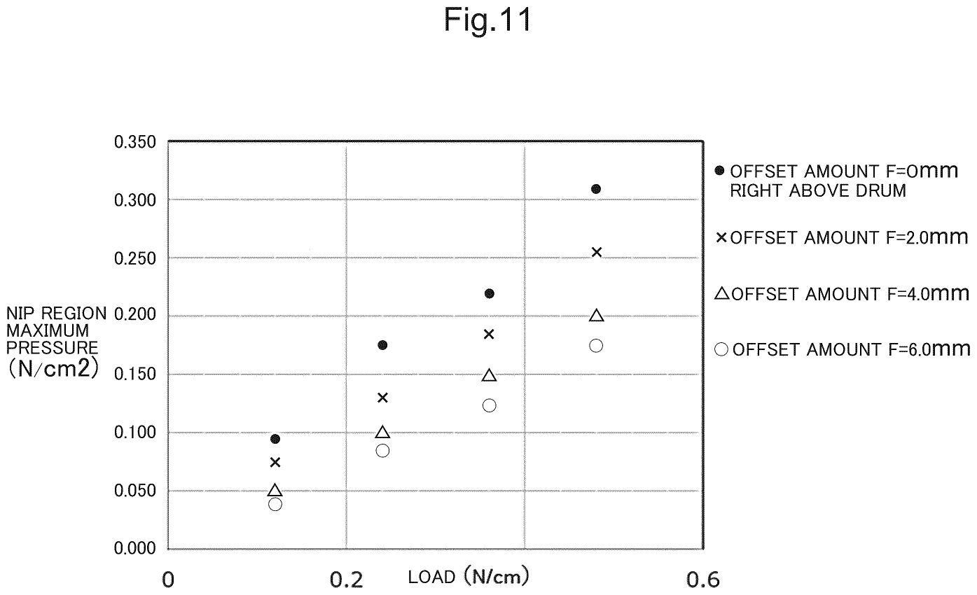

In the graph of FIG. 11, the horizontal axis represents the load N of the primary transfer roller 31, based on the biasing force of the spring 33, and the vertical axis represents the maximum pressure PM at the nip region NP1. The graph indicates the maximum pressure PM relative to the load N, measured when the offset amount F was set to 0 mm, 2.0 mm, 4.0 mm, and 6.0 mm, and the summit 1c of the primary transfer roller 31 was made to intrude toward the photoconductor drum 4 via the intermediate transfer belt 5, by an intrusion amount Kr exceeding 0 mm and equal to or less than 0.5 mm, in the state where the overlap rate Rr was set to be in a range exceeding 0% and equal to or less than 25%. As is apparent from the graph of FIG. 11, when the offset amount F is increased, the maximum pressure PM at the nip region NP1 is reduced. This suggests that the pressure is dispersed over the entirety of the nip region NP1. Accordingly, the load imposed on the photoconductor drum 4 is alleviated, and the photoconductor drum 4 and the intermediate transfer belt 5 can be exempted from suffering a damage, which leads to prolonged service life of these components.

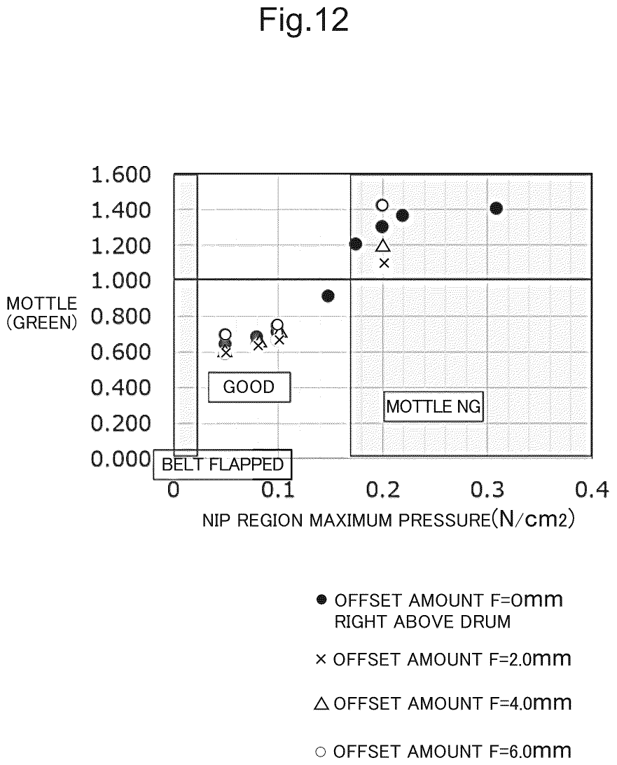

In the graph of FIG. 12, the horizontal axis represents the maximum pressure PM at the nip region NP1, and the vertical axis represents a mottle index indicating the graininess of the image, in a numerical form. The graph indicates the mottle index relative to the maximum pressure PM, acquired when the offset amount F was set to 0 mm, 2.0 mm, 4.0 mm, and 6.0 mm. The lower the mottle index is, the higher the image quality becomes, and therefore it is preferable to set the mottle index to a value lower than 1. As is apparent from the graph of FIG. 12, the mottle index can be set to a value lower than 1, when the maximum pressure PM at the nip region NP1 is 0.15 or lower. Presumably, this is because the adhesiveness of the toner on the surface of the intermediate transfer belt 5 is reduced, which leads to improved image quality.

Referring to FIG. 11, it is understood that, to set the maximum pressure PM at the nip region NP1 to a value equal to or lower than 0.15, the load N applied to the primary transfer roller 31 by the biasing force of the spring 33 has to be appropriately adjusted, according to the size of the recording sheet (width of the intermediate transfer belt 5), and then the offset amount F has to be set to 0 mm, 2.0 mm, 4.0 mm, and 6.0 mm.

From the above, it may be understood that, when the summit 1c of the primary transfer roller 31 is made to intrude toward the photoconductor drum 4 via the intermediate transfer belt 5, in the state where a part of the second contact region 4S and a part of the first contact region 1S are made to overlap with each other, for example when the overlap area Rs is set to a value smaller than the maximum value Vs, it is preferable to set the offset amount F to be in a range of 0.5 mm≤F≤6.0 mm, or more preferably 3.0 mm≤F≤6.0 mm, in consideration of the results of the experiments 2-2 to 2-4 specified in FIG. 6A, FIG. 6B to FIG. 8A, FIG. 8B, because with such setting the adhesiveness of the toner on the surface of the intermediate transfer belt 5 is reduced, which leads to improved image quality, and also the load imposed on the photoconductor drum 4 is alleviated, and the photoconductor drum 4 and the intermediate transfer belt 5 can be exempted from suffering a damage, which leads to prolonged service life of these components.

According to the foregoing embodiment, the upstream end 1a of the second contact region 1S is located on the upstream with respect to the downstream 4b of the first contact region 4S, in the moving direction A of the intermediate transfer belt 5, and the rotational center 1x of the primary transfer roller 31 is spaced from the rotational center 4x of the photoconductor drum 4 to the downstream side, in the moving direction A of the intermediate transfer belt 5. Instead, the downstream end 1b of the second contact region 1S may be located on the downstream side with respect to the upstream end 4a of the first contact region 4S, and the center 1x of the primary transfer roller 31 may be spaced from the center 4x of the photoconductor drum 4 to the upstream side, to make the upstream-side portion of the first contact region 4S (nip region NP1) on the photoconductor drum 4, and the downstream-side portion of the second contact region 1S on the primary transfer roller 31 overlap with each other. Such a configuration also provides, as in the foregoing embodiment, the advantageous effects that, without the need to increase the spring load applied to the primary transfer roller 31, the image defect can be suppressed, and the mechanical service life of the photoconductor drum 4 and the intermediate transfer belt 31 can be prolonged. In addition, properly setting the offset amount F, the overlap area Rs, and the intrusion amount Kr as in the experiment 1 and experiment 2, further assures that the mentioned advantageous effects are attained.

In some of the existing image forming apparatuses, the primary transfer roller is offset to the downstream side with respect to the photoconductor drum, and the region on the primary transfer roller in contact with the intermediate transfer belt, is spaced to the downstream side, from the region on the photoconductor drum in contact with the intermediate transfer belt. In the case of the image forming apparatus configured as above, the region on the photoconductor drum in contact with the intermediate transfer belt is spaced from the primary transfer roller. Accordingly, the nip region is spaced from the primary transfer roller. In such a case, the pressure applied to the recording sheet in the nip region is prone to become unstable, and an image defect (banding) arising from the revolving motion of the intermediate transfer belt may be incurred. In addition, increasing the spring load applied to the primary transfer roller, thereby increasing the pressure applied by the primary transfer roller to the photoconductor drum via the intermediate transfer belt, to avoid the mentioned drawback, leads to an increase in pressure in the nip region, which increases the load imposed on the photoconductor drum and the intermediate transfer belt, thereby shortening the mechanical service life of these components.

According to the foregoing embodiment, in contrast, the banding arising from the revolving motion of the intermediate transfer belt can be suppressed, so that the image quality is improved, and the mechanical service life of the photoconductor drum and intermediate transfer belt can be prevented from being shortened.

Further, the configurations described above with reference to FIG. 1 to FIG. 12 are merely exemplary, and in no way intended to limit the disclosure to those configurations.

While the present disclosure has been described in detail with reference to the embodiments thereof, it would be apparent to those skilled in the art that various changes and modifications may be made therein within the scope defined by the appended claims.

What is claimed is:

1. An image forming apparatus comprising:
a photoconductor drum that carries an electrostatic latent image, which is developed into a toner image by application of toner;
an intermediate transfer belt made to move in contact with the photoconductor drum; and
a primary transfer roller opposed to the photoconductor drum via the intermediate transfer belt, and configured to press the intermediate transfer belt against the photoconductor drum, thereby transferring the toner image on the photoconductor drum, to the intermediate transfer belt from the photoconductor drum,
wherein a part of a first contact region and a part of a second contact region are made to overlap with each other, the first contact region being a contact region between the intermediate transfer belt and the photoconductor drum, and the second contact region being a contact region between the intermediate transfer belt and the primary transfer roller, and
a summit of the primary transfer roller, protruding farthest toward the photoconductor drum, in a direction in which the photoconductor drum and the primary transfer roller are aligned across the intermediate transfer belt, is set to intrude into a side where the photoreceptor drum is located, via the intermediate transfer belt.

2. The image forming apparatus according to claim 1,
wherein an intrusion amount of the summit of the primary transfer roller into the side where the photoreceptor drum is located, relative to an amount of the overlapping, is set within a predetermined proper range.

3. The image forming apparatus according to claim 2,
wherein the overlapping amount is set to equal to or lower than 40% of a maximum value of the overlapping amount, and the proper range of the intrusion amount is set to a range exceeding 0 mm and equal to or less than 0.5 mm.

4. The image forming apparatus according to claim 2,
wherein the overlapping amount is set to equal to or lower than 30% of the maximum value of the overlapping amount, and the proper range of the intrusion amount is set to a range exceeding 0 mm and equal to or less than 1.0 mm.

5. The image forming apparatus according to claim 2,
wherein the overlapping amount is set to equal to or lower than 20% of the maximum value of the overlapping amount, and the proper range of the intrusion amount is set to a range exceeding 0 mm and equal to or less than 1.5 mm.

6. The image forming apparatus according to claim 1,
wherein an offset amount F, corresponding to a distance along a moving direction of the intermediate transfer belt, between a rotational center of the photoconductor drum and a rotational center of the primary transfer roller, is set to be in a range of 0.5 mm≤F≤6.0 mm.

7. The image forming apparatus according to claim 1,
wherein an offset amount F, corresponding to a distance along a moving direction of the intermediate transfer belt, between a rotational center of the photoconductor drum and a rotational center of the primary transfer roller, is set to be in a range of 3.0 mm≤F≤6.0 mm.

8. The image forming apparatus according to claim 1,
wherein a rotational center of the primary transfer roller is spaced from a rotational center of the photoconductor drum, to a downstream side in a moving direction of the intermediate transfer belt.

9. The image forming apparatus according to claim 1,
wherein a rotational center of the primary transfer roller is spaced from a rotational center of the photoconductor drum, to an upstream side in a moving direction of the intermediate transfer belt.

10. The image forming apparatus according to claim 1,
wherein, in a moving direction of the intermediate transfer belt, an upstream end of the second contact region is located on an upstream side with respect to a downstream end of the first contact region, and a rotational center of the primary transfer roller is spaced from a rotational center the photoconductor drum, to a downstream side.

11. The image forming apparatus according to claim 1,
wherein, in a moving direction of the intermediate transfer belt, a downstream end of the second contact region is located on a downstream side with respect to an upstream end of the first contact region, and a rotational center of the primary transfer roller is spaced from a rotational center the photoconductor drum, to an upstream side.

12. The image forming apparatus according to claim 1,
wherein a transfer current It, representing a current flowing between the primary transfer roller and the photoconductor drum, when a transfer bias is being applied to the primary transfer roller, is set to be in a range of |2.0 μA|≤It≤|40.0 μA|.

13. The image forming apparatus according to claim 1, further comprising a biasing device that biases the primary transfer roller thereby pressing the primary transfer roller against the intermediate transfer belt,
wherein a load applied to the primary transfer roller by the biasing device is set to be in a range between 0.6N and 3.0N, both ends inclusive.

14. The image forming apparatus according to claim 1, further comprising a biasing device that biases the primary transfer roller thereby pressing the primary transfer roller against the intermediate transfer belt,
wherein a load applied to the primary transfer roller by the biasing device is set to be in a range between 0.6N and 1.4N, both ends inclusive.

15. The image forming apparatus according to claim 1,
wherein, in a case where an elastic belt is employed as the intermediate transfer belt, a thickness of the intermediate transfer belt is set to be in a range between 30 μm and 400 μm, both ends inclusive, and in a case where a resin belt is employed as the intermediate transfer belt, a thickness of the intermediate transfer belt is set to be in a range between 30 μm and 150 μm, both ends inclusive.

16. The image forming apparatus according to claim 1,
wherein a tension of the intermediate transfer belt is set to be in a range between 15N and 45N, both ends inclusive.
